(19) United States
(12) Patent Application Publication
(10) Pub. No.: US 2024/0403096 A1
(43) Pub. Date: Dec. 5, 2024

(54) HANDLING CONTAINER VOLUME CREATION IN A VIRTUALIZED ENVIRONMENT

(71) Applicant: VMWARE, INC., Palo Alto, CA (US)

(72) Inventor: KASHISH BHATIA, Bangalore (IN)

(21) Appl. No.: 18/229,199

(22) Filed: Aug. 2, 2023

(30) Foreign Application Priority Data
Jun. 2, 2023 (IN) 202341038176

(51) Int. Cl. G06F 9/455

(52) U.S. Cl. CPC G06F 9/45558; G06F 2009/45562

(57) ABSTRACT

An example method of creating a volume for a container of container cluster executing in a computer system includes: receiving, at a container volume driver executing in the computer system, a request to create the volume from a container agent, the container agent executing in the computer system on behalf of the container; determining, by the container volume driver in cooperation with a storage stack, that insufficient available space exists in a virtual disk pool to store the volume; sending, by the container volume driver to the storage stack, a delete request targeting a portion of the physical storage that stores a freeable portion of the plurality of allocated volumes; requesting, by the container volume driver, the storage stack to activate a garbage collector that processes the delete request; and requesting, by the container volume driver, the container agent to retry the request to create the volume.

### RELATED APPLICATIONS

Benefit is claimed under 35 U.S.C. 119 (a)-(d) to Foreign application No. 202341038176 filed in India entitled “HANDLING CONTAINER VOLUME CREATION IN A VIRTUALIZED ENVIRONMENT”, on Jun. 2, 2023, by VMware, Inc., which is herein incorporated in its entirety by reference for all purposes.

### BACKGROUND

Applications today are deployed onto a combination of virtual machines (VMs), containers, application services, and more. For deploying such applications, a container orchestrator (CO) such as Kubernetes® has gained in popularity among application developers. Kubernetes provides a platform for automating deployment, scaling, and operations of application containers across clusters of hosts. It offers flexibility in application development and offers several useful tools for scaling.

A CO groups containers and executes them on nodes in a cluster (also referred to as “node cluster”). Containers in the same node share the same resources and network and maintain a degree of isolation from containers in other nodes. In a typical deployment, a node includes an operating system (OS), such as Linux®, and a container engine executing on top of the OS that supports the containers. A node can a virtual machine (VM) or a non-virtualized host computer. A CO supports stateful applications, where containers use persistent volumes (PVs) to store persistent data.

With containers used extensively in cloud environments in an on-demand basis, PVs attached to such containers are scheduled for creation based on conditional events. A conditional event can be some amount of time passing since creation of the container, a dependency on creation of other PV(s), and/or some other type of conditional business logic. While PV creation may be delayed based on conditional events, the CO checks for available storage capacity at the time the container is created. Sufficient storage capacity may exist when the container is created. When the conditional event occurs at a future time, however, PV creation can fail due to outdated storage capacity information. The storage capacity available at the time the container was created may have been consumed by other resources by the time the conditional event occurs and the request to create the PV is submitted. Such a condition may require user intervention and may result in interruption of critical business functions.

### SUMMARY

In an embodiment, a method of creating a volume for a container of container cluster executing in a computer system and managed by a container manager is described. A container volume driver executes in the computer system and receives a request to create the volume from a container agent. The container agent executes in the computer system on behalf of the container and as a client of the container volume driver. The container volume driver cooperates with a storage stack and determines that insufficient available space exists in a virtual disk pool to store the volume. The virtual disk pool includes at least one virtual disk and is stored in physical storage accessible by the computer system. The virtual disk pool stores a plurality of allocated volumes previously created for the container cluster. The container volume driver sends to the storage stack a delete request targeting a portion of the physical storage that stores a freeable portion of the plurality of allocated volumes. The container volume driver requests the storage stack to activate a garbage collector that processes the delete request. The container volume driver requests the container agent to retry the request to create the volume.

Further embodiments include a non-transitory computer-readable storage medium comprising instructions that cause a computer system to carry/out the above method, as well as a computer system configured to carry out the above method.

### BRIEF DESCRIPTION OF THE DRAWINGS

FIG. 1 is a block diagram depicting an example of virtualized infrastructure that supports the techniques described herein.

FIG. 2A is a block diagram depicting logical components of a hypervisor, a VM managed by the hypervisor, and physical storage according to embodiments.

FIG. 2B is a block diagram depicting a logical relation between volumes and physical storage according to embodiments.

FIG. 3A is a block diagram depicting a container configuration file according to embodiments.

FIG. 3B depicts an example portion of a container configuration file.

FIG. 4 is a block diagram depicting a logic flow of a container manager processing a container configuration file according to embodiments.

FIG. 5A is a block diagram depicting a container table according to embodiments.

FIG. 5B is a block diagram depicting a volume table according to embodiments.

FIG. 6 is a flow diagram depicting a method of processing a container configuration file according to embodiments.

FIG. 7 is a flow diagram depicting a method of handling scheduled volume creation jobs according to an embodiment.

FIG. 8 is a flow diagram depicting a method of processing container creation at a container agent according to embodiments.

FIG. 9 is a flow diagram depicting a method of handling a request to create a volume at a container volume driver of a hypervisor according to embodiments.

FIG. 10 is a flow diagram depicting a method of reclaiming freeable space according to an embodiment.

FIG. 11 is a flow diagram depicting a method of reclaiming freeable space according to an embodiment.

### DETAILED DESCRIPTION

Handling container volume creation in a virtualized environment is described. In embodiments, the virtualized environment includes a host or a cluster of hosts, where each host comprises a computer system. Each host includes a hardware platform and a hypervisor executing thereon. The hypervisor includes a container volume driver and a storage stack. A container cluster executes on the host(s). The containers of the container cluster execute in virtual machines (VMs) managed by the hypervisor. Each VM includes a container agent, executing on behalf of container(s) therein and as a client of the container volume driver. The container agent sends requests to create volumes for the container(s) to the container volume driver. The container volume driver cooperates with the storage stack to determine if available space exists in a virtual disk pool to store the volume. The virtual disk pool includes at least one virtual disk and is stored in physical storage accessible by the host(s).

The virtual disk pool stores a plurality of allocated volumes that were previously created for containers in the container cluster. Each of the allocated volumes is stored on a virtual disk in the pool. When the container volume driver receives the request to create the volume, there may be insufficient available space for the volume. However, the allocated volumes may be consuming more space than necessary. There may be freeable portions of the allocated volumes stored on the physical storage. A freeable portion comprises any allocated volume or any portion of an allocated volume that is no longer in use by the container cluster and can be freed. One example of a freeable portion is an allocated volume that is no longer associated with any container in the container cluster (“dangling volume”). Another example of a freeable portion is all or a portion of an allocated volume that the container cluster has targeted for deletion.

If insufficient available space exists to store the volume being created, the container volume driver attempts to reclaim freeable space in the virtual disk pool to available space. The container volume driver identifies the freeable portions of the allocated volumes. The container volume driver sends to the storage stack delete requests targeting portions of the physical storage that store the identified freeable portions of the allocated volumes. The storage stack includes a garbage collector that periodically processes delete requests in its queue. Rather than waiting for the garbage collector to wake up on its own, the container volume driver requests the storage stack to activate the garbage collector immediately. In the meantime, the container volume driver requests the container agent to retry creating the volume after some delay.

In embodiments, the container cluster is managed by a container manager, such as a container orchestrator (CO). The container manager receives a configuration file having a definition of the container cluster and a definition of one or more volumes. Some volume definitions may direct immediate creation of described volumes (“immediate volumes”). The container manager will create immediate volumes at or around the time of creation of the container cluster. Other volume definitions may schedule creation of described volumes according to creation conditions (“scheduled volumes”). A creation condition must be satisfied before the container manager will create the corresponding scheduled volume. For example, a creation condition can specify that a scheduled volume be created at some time T1 after a creation time T of the container cluster. In another example, a creation condition can specify that a scheduled volume be created at some time T2, but only after creation of another volume created at a time T1, where T2 is after T1, which is after a creation time T of the container cluster.

Outdated storage capacity information can cause creation of scheduled volumes to fail. One way to address this problem is to reserve space for scheduled volumes at the time the container cluster is created. However, this discards the purpose of scheduling volume creation, e.g., creating volumes on as-needed basis in a dynamic cloud environment. Also this leads to inefficient use of storage resources. Another way to address this problem is to require human intervention to deploy additional storage resources when scheduled volume creation fails. However, manual intervention is inefficient and not optimal for critical applications that need volume creation at runtime. The techniques described herein allow for creating scheduled volumes on-demand without reserving storage space at the time the container cluster is created. Requests to create scheduled volumes are sent to the hypervisor as the conditions are met. If insufficient available space exists, the hypervisor attempts to reclaim freeable space without user intervention and requests the container agent to retry the request. If enough freeable space is reclaimed, subsequent retries will be successful. These and further aspects of the embodiments are described below with respect to the drawings.

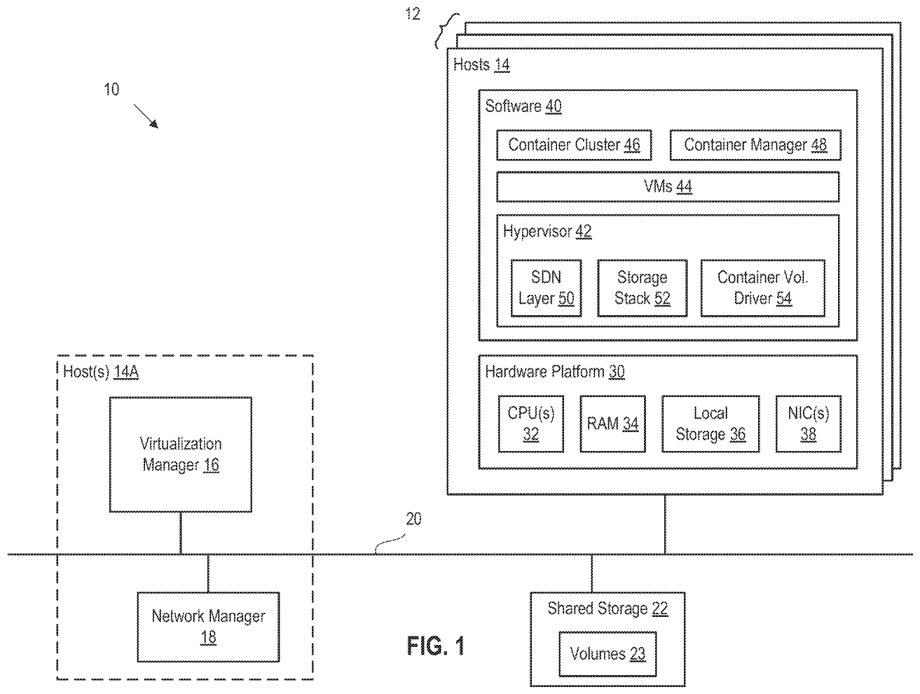

FIG. 1 is a block diagram depicting an example of virtualized infrastructure 10 that supports the techniques described herein. In general, virtualized infrastructure comprises computers (hosts) having hardware (e.g., processor, memory, storage, network) and virtualization software executing on the hardware. In the example, virtualized infrastructure 10 includes a cluster of hosts 14 (“host cluster 12”) that may be constructed on hardware platforms such as an x86 or ARM architecture platforms. For purposes of clarity, only one host cluster 12 is shown. However, virtualized infrastructure 10 can include many of such host clusters 12. As shown, a hardware platform 30 of each host 14 includes conventional components of a computing device, such as one or more central processing units (CPUs) 32, system memory (e.g., random access memory (RAM) 34), one or more network interface controllers (NICs) 38, and optionally local storage 36.

CPUs 32 are configured to execute instructions, for example, executable instructions that perform one or more operations described herein, which may be stored in RAM 34. The system memory is connected to a memory controller in CPU 32 or on hardware platform 30 and is typically volatile memory (e.g., RAM 34). Storage (e.g., local storage 36) is connected to a peripheral interface in CPU 32 or on hardware platform 30 (either directly or through another interface, such as NICs 38). Storage is persistent (nonvolatile). As used herein, the term memory (as in system memory) is distinct from the term storage (as in local storage or shared storage). NICs 38 enable host 14 to communicate with other devices through a physical network 20. Physical network 20 enables communication between hosts 14 and between other components and hosts 14.

In the embodiment illustrated in FIG. 1, hosts 14 access shared storage 22 by using NICs 38 to connect to network 20. In another embodiment, each host 14 contains a host bus adapter (HBA) through which input/output operations (IOs) are sent to shared storage 22 over a separate network (e.g., a fibre channel (FC) network). Shared storage 22 include one or more storage arrays, such as a storage area network (SAN), network attached storage (NAS), or the like. Shared storage 22 may comprise magnetic disks, solid-state disks, flash memory, and the like as well as combinations thereof. In some embodiments, hosts 14 include local storage 36 (e.g., hard disk drives, solid-state drives, etc.). Local storage 36 in each host 14 can be aggregated and provisioned as part of a virtual SAN, which is another form of shared storage 22.

Software 40 of each host 14 provides a virtualization layer, referred to herein as a hypervisor 42, which directly executes on hardware platform 30. In an embodiment, there is no intervening software, such as a host operating system (OS), between hypervisor 42 and hardware platform 30. Thus, hypervisor 42 is a Type-1 hypervisor (also known as a “bare-metal” hypervisor). As a result, the virtualization layer in host cluster 12 (collectively hypervisors 42) is a bare-metal virtualization layer executing directly on host hardware platforms. Hypervisor 42 abstracts processor, memory, storage, and network resources of hardware platform 30 to provide a virtual machine execution space within which multiple virtual machines (VM) 44 may be concurrently instantiated and executed. A container cluster 46 and a container manager 48 execute in VMs 44. Container cluster 46 comprises a plurality of containers. Containers are a form of OS virtualization. Containers use features of an OS, such as a guest OS executing in VM 44, to isolate processes and control process access to underlying hardware, such as virtual hardware of VM 44. Container manager 48 controls the lifecycle of container cluster 46. Container manager 48 can be a container orchestrator (CO), such as Kubernetes or the like.

Hypervisor 42 includes storage stack 52 and container volume driver 54. The containers in container cluster 46 store persistent data in container volumes (“volumes 23”). In the example, volumes 23 are stored in shared storage 22, but may also be stored in local storage 36. A volume is an identifiable unit of storage within physical storage (e.g., shared storage 22). Storage stack 52 comprises software (e.g., a plurality of software layers) configured to manage physical storage (e.g., creating virtual disks, formatting virtual disks with filesystems) and the lifecycle of volumes 23 (e.g., creating volumes, deleting volumes). Container volume driver 54 provides an interface to storage stack 52 on behalf of container cluster 46. Requests to create volumes 23, delete volumes 23, read/write/update/delete data in volumes, and the like generated by container cluster 46 are received by container volume driver 54. Containers in container cluster 46 can use volumes 23 as “persistent volumes.” For example, containers use persistent volumes to persist their state and data.

In the example, host cluster 12 is configured with a software-defined (SDN) layer 50. SDN layer 50 includes logical network services executing on virtualized infrastructure in host cluster 12. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure.

A virtualization manager 16 is a non-virtualized or virtual server that manages host cluster 12 and the virtualization layer therein. Virtualization manager 16 installs agent(s) in hypervisor 42 to add a host 14 as a managed entity. Virtualization manager 16 logically groups hosts 14 into host cluster 12 to provide cluster-level functions to hosts 14, such as VM migration between hosts 14 (e.g., for load balancing), distributed power management, dynamic VM placement according to affinity and anti-affinity rules, and high-availability. The number of hosts 14 in host cluster 12 may be one or many. Virtualization manager 16 can manage more than one host cluster 12. Virtualized infrastructure 10 can include more than one virtualization manager 16, each managing one or more host clusters 12.

In the example, virtualized infrastructure 10 further includes a network manager 18. Network manager 18 is a non-virtualized or virtual server that orchestrates SDN layer 50. Network manager 18 installs additional agents in hypervisor 42 to add a host 14 as a managed entity. In the example, virtualization manager 16 and network manager 18 execute on hosts 14A, which are selected ones of hosts 14 and which form a management cluster.

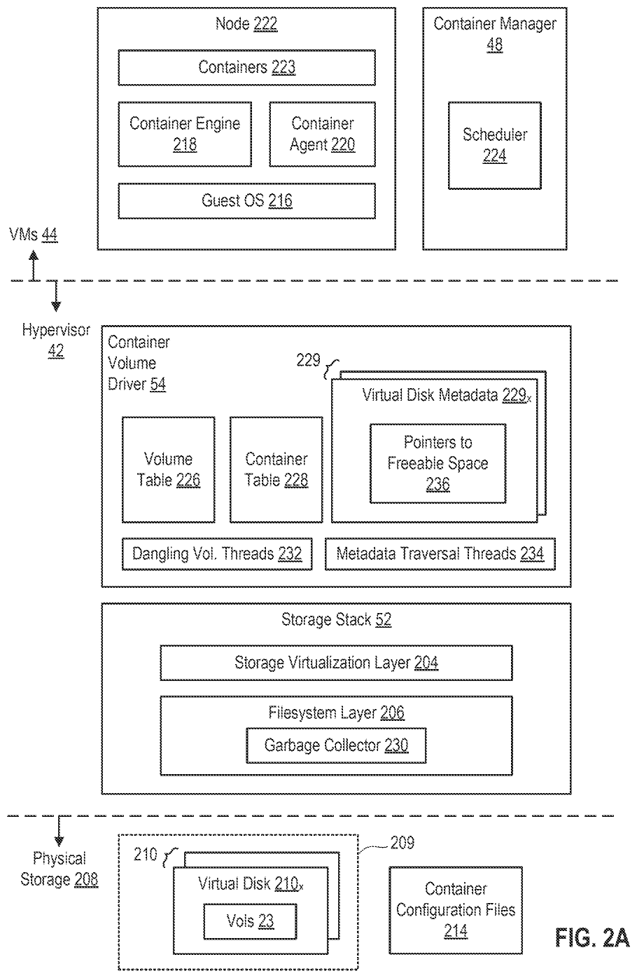

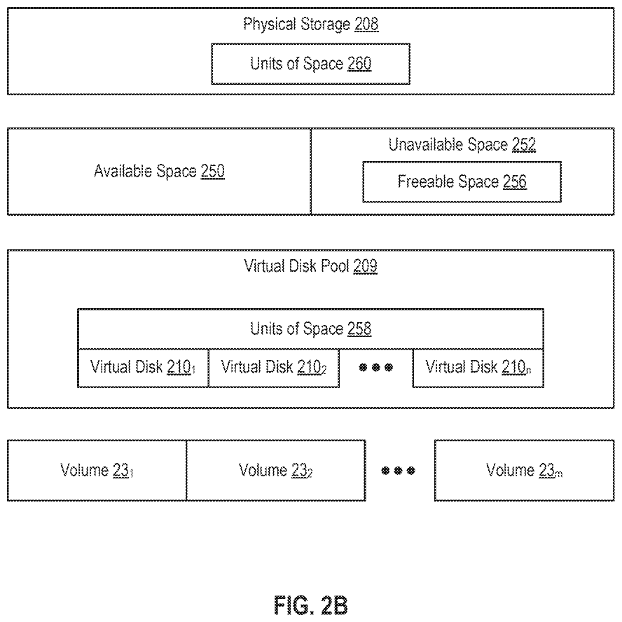

FIG. 2A is a block diagram depicting logical components of a hypervisor 42, a VM 44 managed by the hypervisor 42, and physical storage 208 according to embodiments. Storage stack 52 of hypervisor 42 includes a storage virtualization layer 204 and a filesystem layer 206. Storage virtualization layer 204 is configured to manage virtualization of physical storage 208, including lifecycle management of virtual disks 210. A virtual disk 210ₓ (x indicating an arbitrary one of virtual disks 210) emulates a block-based storage device. Virtual disks 210 are backed by physical storage 208, which can include shared storage 22 and/or local storage 36. Physical storage 208 can be block storage, file storage, object storage, or the like. Virtual disks 210 are agnostic to the type of underlying physical storage. Virtual disks 210 can be independent from VMs 44. That is, each virtual disk 210ₓ exists independent of the lifecycle of VMs 44 and is not tied to any one VM 44. Such a virtual disk 210ₓ may be referred to as a first-class virtual disk. Virtual disks 210 store volumes 23 for use by container cluster 46. Each volume 23 is a logical portion of a virtual disk 210. Thus, virtual disks 210 can comprise a virtual disk pool 209 allocated to container cluster 46 for the purpose of storing volumes 23.

Filesystem layer 206 is configured for file and block management of storage devices, including underlying physical storage 208 and virtual disks 210. Storage stack 52 can include other layers (not shown) for managing non-block-based physical storage, such as object storage or file storage. Each virtual disk 210ₓ can be formatted with a filesystem (e.g., ext4) or remain unformatted.

FIG. 2B is a block diagram depicting a logical relation between volumes 23 and physical storage 208 according to embodiments. A set of volumes 23₁ . . . 23ₘ is allocated for container cluster 46 (where m is an integer greater than zero). The volumes 23₁ . . . 23ₘ are stored on virtual disks 210₁ . . . 210ₙ in virtual disk pool 209 (where n is an integer greater than zero). Volumes 23, which are allocated volumes for container cluster 46, create unavailable space 252 in virtual disk pool 209. Remaining space in virtual disk pool is available space 250 into which any new volume can be allocated. Available space 250 and unavailable space 252 are each measured in units of space 258 in virtual disk pool 209. Since virtual disks 210 emulate block devices, units of space 258 comprise blocks. Units of space 258 can be identified using some indicia that points to individual units. For example, blocks can be identified by logical block addresses (LBAs), LBA ranges, LBA offsets, LBA offset ranges, and the like. Available space 250 and unavailable space 252 have corresponding portions in physical storage measured by units of space 260. Units of space 260 can be the same or different than units of space 258. For example, physical storage 208 can include block devices and units of space 260 can be blocks. In another example, physical storage 208 can be a virtual SAN and units of space 260 can be objects or portions of objects. Units of space 260 can be identified using some indicia that points to individual units. For example, blocks of physical storage 208 can be identified by LBAs, LBA ranges, etc. Since available space 250 and unavailable space 252 can be expressed using either units of space 258 or units of space 260, the two types of units can be mapped to on another. Thus, a volume 23 in a virtual disk 210 consumes some units of space 258, which are mapped to some units of space 260.

Unavailable space 252 includes freeable space 256. Freeable space 256 comprises portions of unavailable space 252 that are consumed by volumes 23, but are not in use by container cluster 46. For example, a dangling volume consumes space on a virtual disk 210 and in turn space on physical storage 208. However, a dangling volume was created for a container that is no longer part of container cluster 46 and is thus not used by container cluster 46. A dangling volume is freeable space and can be deleted to reclaim the freeable space as available space 250. In another example, containers in container cluster 46 can delete portions of a volume 23 or entire volumes 23 during their operation as part of their logic. Hypervisor 42 receives these deletions from container cluster 46, which are to be processed by storage stack 52. However, before the deletions are processed, the portions of unavailable space targeted by the deletions comprise freeable space 256.

Returning to FIG. 2A, filesystem layer 206 includes a garbage collector 230. Garbage collector 230 includes a queue for delete requests, where each delete request identifies units of space 260 to be freed. Garbage collector 230 can wake up periodically to perform its function of processing delete requests in its queue. Filesystem layer 206 also accepts requests to wake up garbage collector 230 to perform its function on-demand.

VMs 44 implement nodes of a container cluster, such as node 222. A node 222 implemented by a VM 44 includes a guest OS 216, a container engine 218, a container agent 220, and containers 223. Guest OS 216 can be any known OS, such as Linux® or any derivative thereof. Container engine 218 can be any known container runtime, such as runC, containerd, or the like or derivatives thereof. Container engine 218 cooperates with guest OS 216 to isolate resources for containers 223, pull container images, and manage container lifecycle among other functions. Container agent 220 is an agent for container manager 48. Container agent 220 receives commands from container manager 48, including creating containers and creating volumes. Container agent 220 cooperates with container engine 218 to create containers 223. Container agent 220 cooperates with container volume driver 54 to create volumes 23 for containers 223. Container agent 220 functions on behalf of containers 223 to send requests from containers 223 to hypervisor 42. Container agent 220 can send commands to delete data from volumes 23 to container volume driver 54.

Container volume driver 54 functions as a server for receiving requests and commands from container agents 220 in VMs 44. Container volume driver 54 maintains metadata, which includes volume table 226, container table 228, and virtual disk pool metadata 229. Volume table 226 includes mappings that relate volumes 23 and references to units of space (expressed in cither units 260 or units 258). Container table 228 includes mappings that relate containers 223, virtual disks 210, and volumes 23. Each virtual disk metadata 229ₓ (x representing an arbitrary virtual disk metadata 229) corresponds with one of virtual disks 210. Each virtual disk metadata 229ₓ tracks pointers to freeable space 236 (expressed in units 258 or units 260). For example, virtual disk metadata 229ₓ can include an interval tree of LBA ranges.

In operation, container volume driver 54 can include dangling volume threads 232 and metadata traversal threads 234. These threads attempt to free space on virtual disks 210, as described further below.

Container manager 48 accesses container configuration files 214 for creating containers 223 and volumes 23. A container configuration file 214 can include a definition of containers and a definition of volumes for use by the containers. Container manager 48 processes container configuration file 214 to generate commands for creating containers 223 and creating volumes 23. Container manager 48 includes scheduler 224. Some create tasks defined in a container configuration file 214 can be conditional, such as creation of a volume in response to a conditional event (“scheduled volume”). Container manager 48 sends such conditional create tasks to scheduler 224, which will execute them upon determining the conditions have been satisfied.

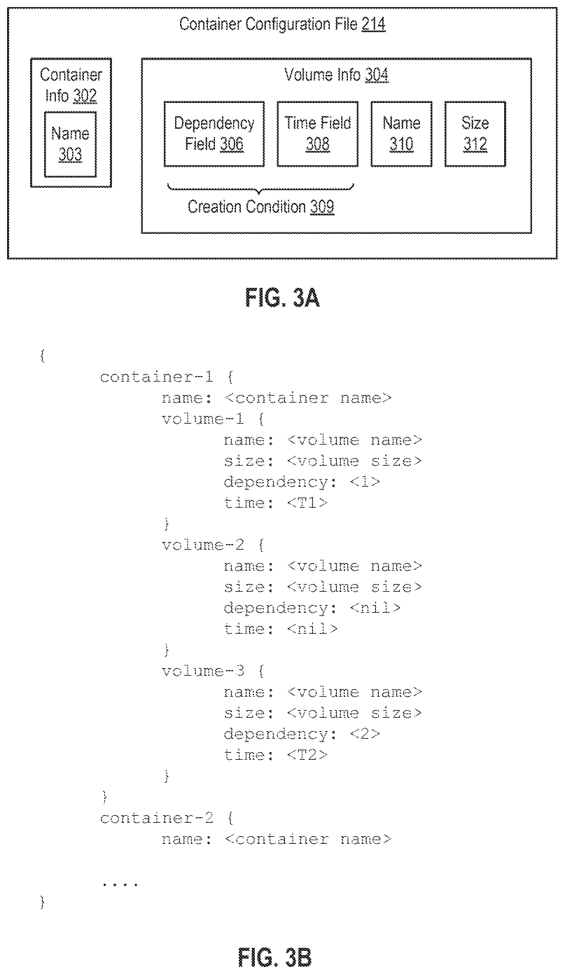

FIG. 3A is a block diagram depicting a container configuration file 214 according to embodiments. Container configuration file 214 includes container information 302 and volume information 304. Container information 302 includes a definition for containers, which includes name information 303. Volume information 304 includes a definition for volumes, which includes creation conditions 309, name information 310, and size information 312. Each creation condition 309 can include a dependency field 306 and a time field 308. Dependency field 306 and time field 308 dictate a sequence of volume creation for scheduled volumes. If creation condition 309 is not present, a volume will be created immediately along with the containers (“immediate volumes”).

FIG. 3B depicts an example portion of a container configuration file 214. As shown in FIG. 3B, a container-1 is defined having a volume-1, a volume-2, and a volume-3. The container-1 includes a name and each volume-1, -2, and -3 includes a name, a size, a dependency, and a time. Volume-1 includes a dependency having a sequence number of 1 and a time of T1. Volume-2 has no dependency or time (each set to nil). Volume-3 includes a dependency having a sequence number of 2 and a time T2. In the example of FIG. 3B, volume-2 is an immediate volume and is created immediately after container-1. Volumes-1 and -3 are scheduled volumes. Dependency of sequence number 1 means volume-1 is created after immediate volumes (e.g., volume-2). Dependency of sequence number 2 means volume-3 is created after volume-2. In addition, volume-1 is to be created at a time T1 after the creation time of container-1. Volume-3 is to be created at a time T2 after time T1.

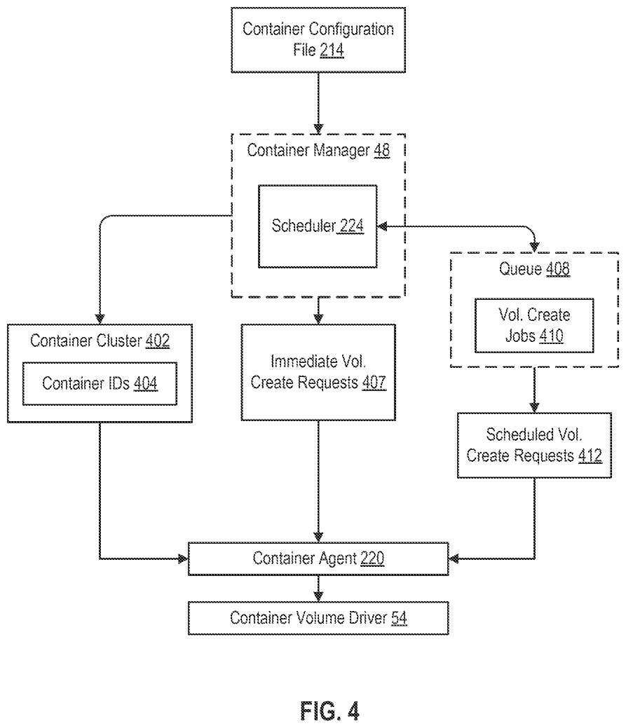

FIG. 4 is a block diagram depicting a logic flow of a container manager 48 processing a container configuration file 214 according to embodiments. Container manager 48 receives container configuration file 214. Container manager 48 creates a container cluster 402 having containers with container IDs 404. Container manager 48 sends a request to create container cluster 402 to a container agent 220 (or multiple container agents in multiple VMs). Container manager 48 sends immediate volume create requests 407 to container agent 220 (or multiple container agents) to create any immediate volumes defined in container configuration file 214. Container manager 48 notifies scheduler 224 of any scheduled volumes defined in container configuration file 214. Scheduler 224 manages a queue 408 of create jobs 410, one for each scheduled volume. As the condition of each scheduled volume is satisfied, its volume create job 410 is activated and scheduler 224 sends a scheduled volume create request 412 to container agent 220. Container agent 220 sends create requests for volumes to container volume driver 54.

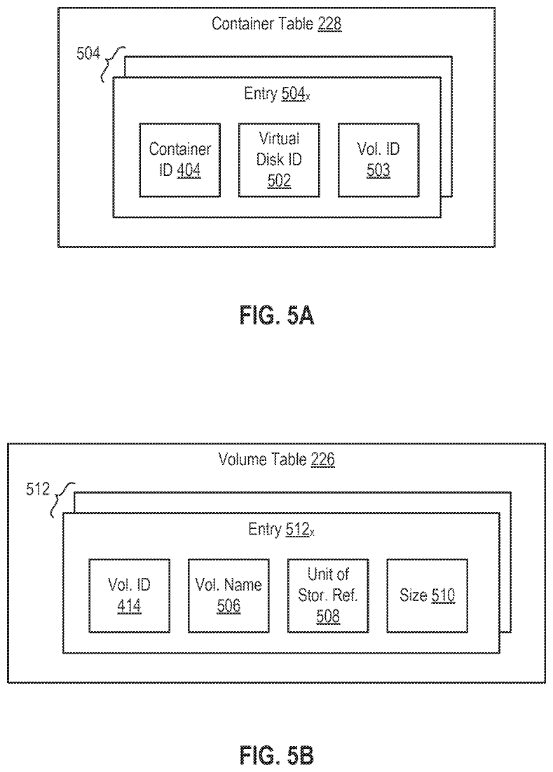

FIG. 5A is a block diagram depicting a container table 228 according to embodiments. Container table 228 includes entries 504. Each entry 504ₓ (x indicating any arbitrary entry) includes a container ID 404, a virtual disk ID 502, and a volume ID 503. Container ID 404 is assigned to each container. Virtual disk ID 502 is assigned to each virtual disk 210. Volume ID is assigned to each volume 23.

FIG. 5B is a block diagram depicting a volume table 226 according to embodiments. Volume table 226 includes entries 512. Each entry 512ₓ (x indicating an arbitrary entry) includes a volume ID 414, a volume name 506, a unit of storage reference 508, and a size 510. Each volume 23 is assigned a volume ID 414. Each volume 23 includes a name 506 and a size 510 specified in container configuration file 214 (e.g., by name 310 and size 312 fields). Unit of storage reference 508 is a reference to a unit of storage consumed by a volume 23 (e.g., a start LBA or start LBA offset when referring to block units).

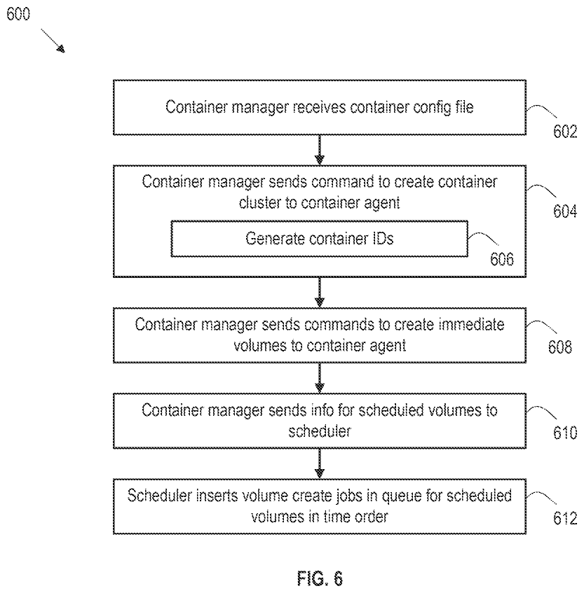

FIG. 6 is a flow diagram depicting a method 600 of processing a container configuration file according to embodiments. Method 600 begins at step 602, where container manager 48 receives a container configuration file 214. At step 604, container manager 48 sends a command to create a container cluster 46 to container agent(s) 220. At step 606, container manager 48 generates container IDs. At step 608, container manager 48 sends commands to create immediate volumes (if any) to container agent(s) 220. At step 610, container manager 48 ends information for scheduled volumes to scheduler 224. At step 612, scheduler 224 inserts volume create jobs in its queue for scheduled volumes in time order.

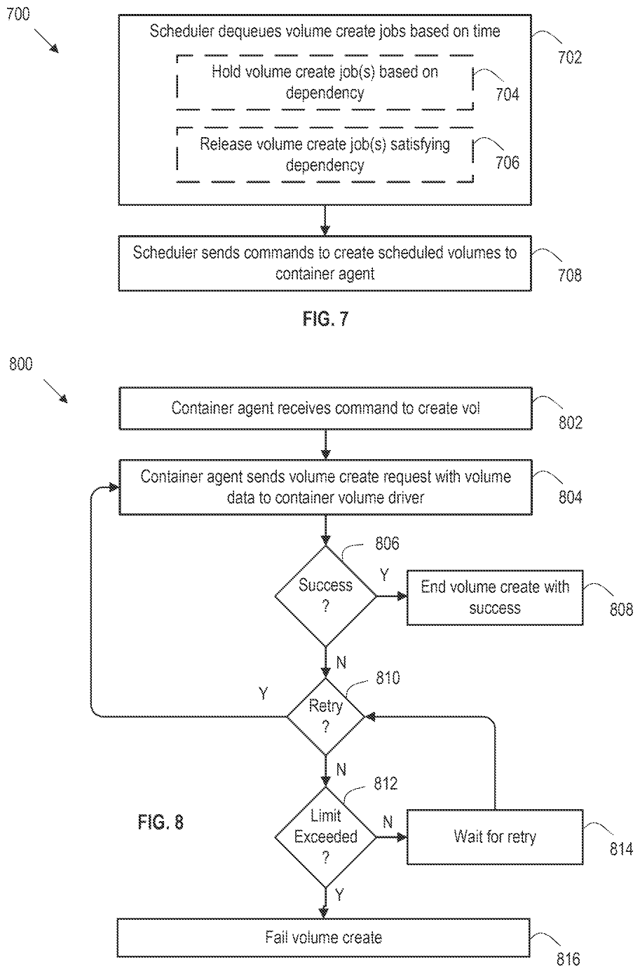

FIG. 7 is a flow diagram depicting a method 700 of handling scheduled volume creation jobs according to an embodiment. Method 700 begins at step 702, where scheduler 224 dequeues volume create jobs based on time. At step 708, scheduler 224 sends commands to container agent(s) 220 to create each scheduled volume as its job is dequeued. In embodiments, at step 704, scheduler 224 holds a create job based on its dependency. That is, the time for the create job may be satisfied, but its dependency may not be satisfied. At step 706, scheduler 224 releases held volume create job(s) satisfying dependency.

FIG. 8 is a flow diagram depicting a method 800 of processing container creation at a container agent according to embodiments. Method 800 begins at step 802, where container agent 220 receives a command to create a volume (e.g., from container manager 48). At step 804, container agent 220 sends a volume create request with volume data (e.g., volume name, volume size) to container volume driver 54. At step 806, if the request results in success, method 800 proceeds to step 808, where container agent 220 ends the volume create process with success. Otherwise, method 800 proceeds from step 806 to step 810. At step 810, container agent 220 determines if the failed create request should be retried. Container volume driver 54 may fail a create request while attempting to reclaim freeable space. Container volume driver 54 may provide indicate a time period after which to retry the create volume request. In case of retry, method 800 returns to step 804. Otherwise, method 800 proceeds to step 812, where container agent 220 determines if a retry limit has been exceeded. If not, method 800 proceeds to step 814 and waits for a retry (e.g., the period specified by container volume driver 54). Method 800 proceeds from step 814 to step 810. If at step 812 the retry limit has been exceeded, method 800 proceeds to step 816, where container agent 220 fails the volume create process. Container agent 220 can inform container manager 48 that the creation request has failed. Container manger 48 in turn can notify a user accordingly.

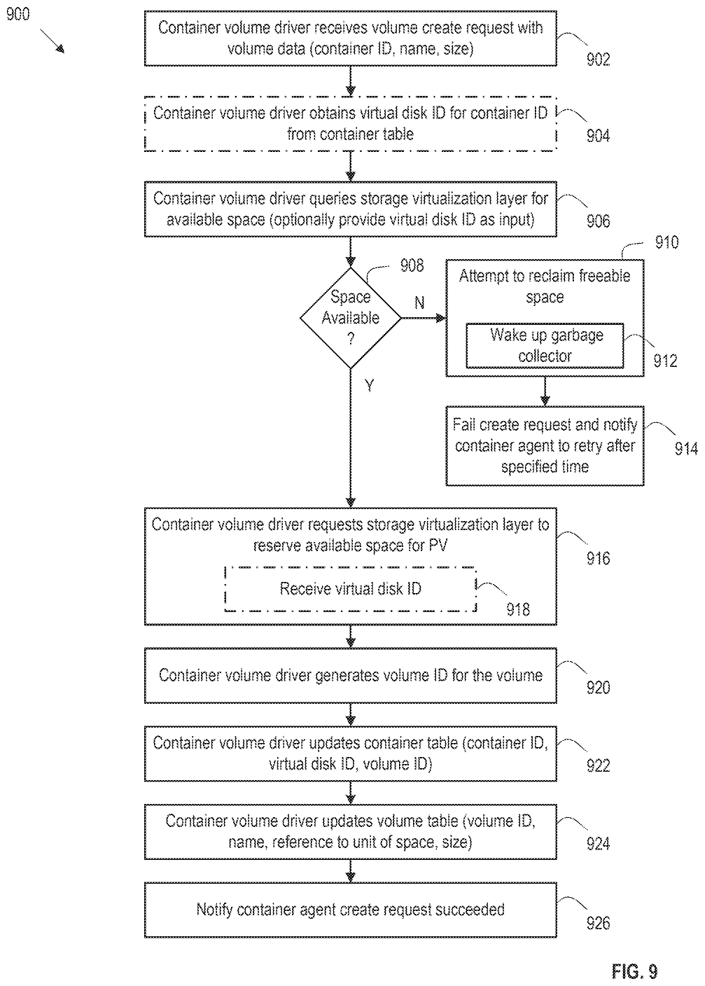

FIG. 9 is a flow diagram depicting a method of handling a request to create a volume at a container volume driver of a hypervisor according to embodiments. Method 900 begins at steep 902, where container volume driver 54 receives a volume create request with volume data (container ID, name, size). At optional step 904, container volume driver 54 obtains a virtual disk ID for the container ID from container table 228. The container identified by container ID may have one or more volumes associated therewith. It may be desirable to have all volumes used by a container on the same virtual disk. Step 904 can be omitted or the container identified by the container ID may have no allocated volumes.

At step 906, container volume driver 54 queries storage virtualization layer 204 for available space. Container volume driver 54 optionally supplies a virtual disk ID as input. If a virtual disk ID is provided, storage virtualization layer 204 determines if available space for the volume exists on the virtual disk as identified. If no virtual disk ID is provided, storage virtualization layer 204 determines if available space exists on any virtual disk 210 in virtual disk pool 209.

If space is available at step 908, method 900 proceeds to step 918. If not space is available at step 908, method 900 proceeds to step 910. At step 910, container volume driver 54 attempts to reclaim freeable space in virtual disk pool 209. Embodiments for reclaiming freeable space are described below. Container volume driver 54 sends delete requests to reclaim the freeable space to filesystem layer 206, which queues the delete queues for garbage collector 230. At step 912, container volume driver 54 requests filesystem layer 206 to wake up garbage collector 230 and immediately process the delete requests in its queue. At step 914, container volume driver 54 fails the create request and notifies container agent 220 to retry after a specified time.

At step 916, given that space is available as determined at step 908, container volume driver 54 requests storage virtualization layer 204 to allocate the volume in available space. Storage virtualization layer 204 allocates the volume on the specified virtual disk if a virtual disk ID is supplied, otherwise on any virtual disk having the available space. At step 918, if storage virtualization layer 204 has selected the virtual disk with available space, container volume driver 54 receives a virtual disk ID for the selected virtual disk.

At step 920, container volume driver 54 generates a volume ID for the volume. At step 922, container volume driver 54 updates container table 228 with an entry for container ID, virtual disk ID, and volume ID. At step 924, container volume driver 54 updates volume table 226 with an entry for volume ID, volume name, reference to unit of space, and volume size. At step 926, container volume driver 54 notifies container agent 220 that the create request has succeeded.

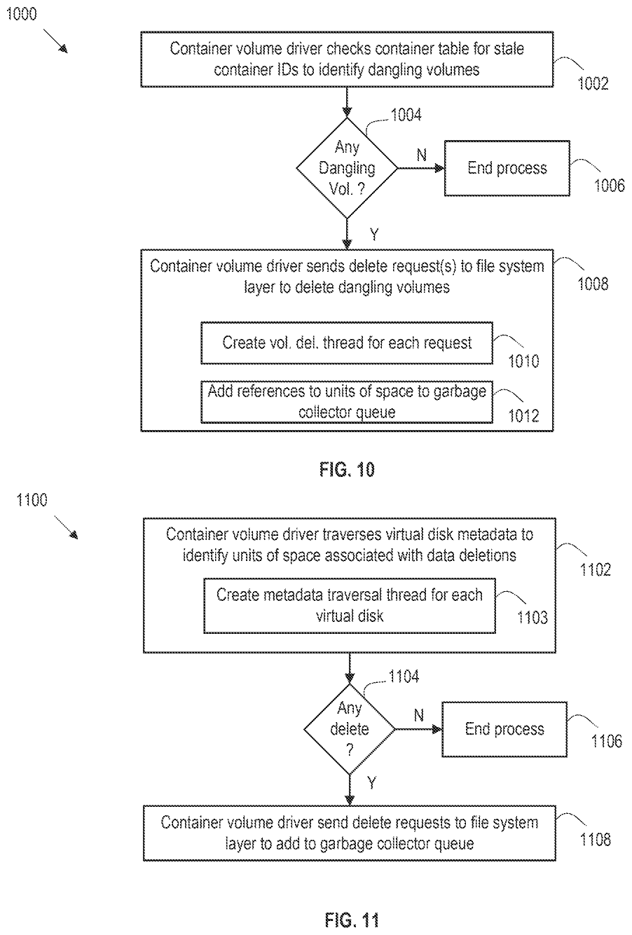

FIG. 10 is a flow diagram depicting a method 1000 of reclaiming freeable space according to an embodiment. Method 1000 begins at step 1002, where container volume driver 54 checks container table 228 for any stale container IDs to identify dangling volumes. A stale container ID is not associated with any container in container cluster 46. If there are no dangling volumes, method 1000 proceeds from step 1004 to step 1006 and ends the process. Otherwise, method 1000 proceeds from step 1004 to step 1008.

At step 1008, container volume driver 54 sends delete requests to filesystem layer 206 to delete dangling volumes. At step 1010, container volume driver 54 creates a dangling volume thread 232 for each dangling volume to be deleted. At step 1012, container volume driver 54 provides a reference to a unit of space for each delete request, which is added to the queue of garbage collector 230 (e.g., LBAs or LBA offsets).

FIG. 11 is a flow diagram depicting a method 1100 of reclaiming freeable space according to an embodiment. Method 1100 begins at step 1102, where container volume driver 54 traverses virtual disk metadata 229 for each virtual disk 210 to identify references to units of space associated with data deletions made by container cluster 46. At step 1103, container volume driver 54 creates a metadata traversal thread 234 for each virtual disk metadata 229. If at step 1104 there are no deletions to process, method 1100 proceeds to step 1106, where container volume driver 54 ends the process. If there are deletions to process at step 1104, method 1100 proceeds to step 1108. At step 1108, container volume driver 54 sends delete requests to filesystem layer 206 to be added to the queue of garbage collector 230. The delete requests include references to units of space for the deletions.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of creating a volume for a container of container cluster executing in a computer system and managed by a container manager, the method comprising:
receiving, at a container volume driver executing in the computer system, a request to create the volume from a container agent, the container agent executing in the computer system on behalf of the container and as a client of the container volume driver;
determining, by the container volume driver in cooperation with a storage stack, that insufficient available space exists in a virtual disk pool to store the volume, the virtual disk pool including at least one virtual disk and stored in physical storage accessible by the computer system, the virtual disk pool storing a plurality of allocated volumes previously created for the container cluster;
sending, by the container volume driver to the storage stack, a delete request targeting a portion of the physical storage that stores a freeable portion of the plurality of allocated volumes;
requesting, by the container volume driver, the storage stack to activate a garbage collector that processes the delete request; and
requesting, by the container volume driver, the container agent to retry the request to create the volume.

2. The method of claim 1, further comprising:
receiving, at the container volume driver, another request to create the volume from the container agent;
determining, by the container volume driver in cooperation with the storage stack, that a virtual disk of the virtual disk pool has available space sufficient to store the volume;
requesting, by the container volume driver, the storage stack to allocate the volume on the virtual disk; and
updating metadata tracked by the container volume driver in response to an identifier of the container, an identifier of the virtual disk, and an identifier of the volume.

3. The method of claim 2, wherein the other request includes volume data comprising a volume name and a volume size, and wherein the container volume driver updates the metadata further in response to the volume name, the volume size, and a reference to a unit of the available space consumed by the volume.

4. The method of claim 3, wherein the step of updating the metadata comprises:
updating a first table that relates container identifiers, virtual disk identifiers, and volume identifiers; and
updating a second table that relates the volume identifiers, volume names, references to units of space, and volume sizes.

5. The method of claim 1, wherein the container volume driver tracks metadata relating container identifiers, virtual disk identifiers, and volume identifiers, and wherein the step of sending the delete request comprises:
identifying a stale container identifier in the metadata, the stale container identifier having no corresponding container in the container cluster, the stale container identifier related to a volume identifier for a dangling volume and a virtual disk identifier for a virtual disk in the virtual disk pool;
wherein the dangling volume comprises the freeable portion of the plurality of allocated volumes.

6. The method of claim 1, wherein the container volume driver maintains virtual disk metadata tracking deletions received by the container volume driver from the container cluster, and wherein the step of sending the delete request comprises:
traversing the virtual disk metadata to identify a deletion targeting a first allocated volume of the plurality of allocated volumes, the freeable portion comprising at least portion of the first allocated volume.

7. The method of claim 1, wherein the computer system includes a hardware platform and a hypervisor executing on the hardware platform, wherein the container volume driver and the storage stack execute as part of the hypervisor, and wherein the container and the container agent execute in a virtual machine (VM) supported by the hypervisor.

8. The method of claim 1, further comprising:
receiving, at the container manager, a configuration file including a definition of the container cluster and a definition of the volume, the definition of the volume including a creation condition;
commanding, by the container manager, the container agent to send the request to create the volume in response to determining that the creation condition in the definition of the volume has been satisfied.

9. The method of claim 8, wherein the creation condition includes a creation time T1 after a creation time T of the container.

10. The method of claim 8, wherein the creation condition includes a creation time T2 and a dependency on creation of another volume with a creation time of T1, T2 occurring after T1, which occurs after a creation time T of the container.

11. A non-transitory computer readable medium comprising instructions to be executed in a computing device to cause the computing device to carry out a method of creating a volume for a container of container cluster executing in a computer system and managed by a container manager, the method comprising:
receiving a request to create the volume from a container agent, the container agent executing in the computer system on behalf of the container;
determining, in cooperation with a storage stack, that insufficient available space exists in a virtual disk pool to store the volume, the virtual disk pool including at least one virtual disk and stored in physical storage accessible by the computer system, the virtual disk pool storing a plurality of allocated volumes previously created for the container cluster;
sending, to the storage stack, a delete request targeting a portion of the physical storage that stores a freeable portion of the plurality of allocated volumes;
requesting the storage stack to activate a garbage collector that processes the delete request; and
requesting the container agent to retry the request to create the volume.

12. The non-transitory computer readable medium of claim 11, further comprising:
receiving another request to create the volume from the container agent;
determining, in cooperation with the storage stack, that a virtual disk of the virtual disk pool has available space sufficient to store the volume;
requesting the storage stack to allocate the volume on the virtual disk; and
updating metadata in response to an identifier of the container, an identifier of the virtual disk, and an identifier of the volume.

13. The non-transitory computer readable medium of claim 11, wherein metadata relates container identifiers, virtual disk identifiers, and volume identifiers, and wherein the step of sending the delete request comprises:
identifying a stale container identifier in the metadata, the stale container identifier having no corresponding container in the container cluster, the stale container identifier related to a volume identifier for a dangling volume and a virtual disk identifier for a virtual disk in the virtual disk pool;
wherein the dangling volume comprises the freeable portion of the plurality of allocated volumes.

14. The non-transitory computer readable medium of claim 11, wherein virtual disk metadata tracks deletions received from the container cluster, and wherein the step of sending the delete request comprises:
traversing the virtual disk metadata to identify a deletion targeting a first allocated volume of the plurality of allocated volumes, the freeable portion comprising at least portion of the first allocated volume.

15. A computer system, comprising:
a hardware platform configured for access to physical storage, the physical storage storing a virtual disk pool comprising at least one virtual disk, the virtual disk pool storing a plurality of allocated volumes previously created for a container cluster;
a hypervisor executing on the hardware platform, the hypervisor including a container volume driver and a storage stack;
a virtual machine (VM) managed by the hypervisor, the VM including a container of the container cluster and a container agent;
wherein the container volume driver is configured to:
receive a request to create a volume from the container agent;
determine, in cooperation with a storage stack, that insufficient available space exists in the virtual disk pool to store the volume;
send, to the storage stack, a delete request targeting a portion of the physical storage that stores a freeable portion of the plurality of allocated volumes;
request the storage stack to activate a garbage collector that processes the delete request; and
request the container agent to retry the request to create the volume.

16. The computer system of claim 15, wherein the container volume driver is configured to:
receive another request to create the volume from the container agent;
determine, in cooperation with the storage stack, that a virtual disk of the virtual disk pool has available space sufficient to store the volume;
request the storage stack to allocate the volume on the virtual disk; and
update metadata tracked by the container volume driver in response to an identifier of the container, an identifier of the virtual disk, and an identifier of the volume.

17. The computer system of claim 16, wherein the other request includes volume data comprising a volume name and a volume size, and wherein the container volume driver updates the metadata further in response to the volume name, the volume size, and a reference to a unit of the available space consumed by the volume.

18. The computer system of claim 17, wherein the container volume driver is configured to:
update a first table that relates container identifiers, virtual disk identifiers, and volume identifiers; and
update a second table that relates the volume identifiers, volume names, references to units of space, and volume sizes.

19. The computer system of claim 15, wherein the container volume driver is configured to:
track metadata relating container identifiers, virtual disk identifiers, and volume identifiers; and
identify a stale container identifier in the metadata, the stale container identifier having no corresponding container in the container cluster, the stale container identifier related to a volume identifier for a dangling volume and a virtual disk identifier for a virtual disk in the virtual disk pool;
wherein the dangling volume comprises the freeable portion of the plurality of allocated volumes.

20. The computer system of claim 15, wherein the container volume driver is configured to:
maintain virtual disk metadata that tracks deletions received from the container cluster; and
traverse the virtual disk metadata to identify a deletion targeting a first allocated volume of the plurality of allocated volumes, the freeable portion comprising at least portion of the first allocated volume.
